(19) United States
(12) Patent Application Publication
(10) Pub. No.: US 2019/0170626 A1
(43) Pub. Date: Jun. 6, 2019

(54) APPARATUS AND METHOD FOR FREEZING SPECIMENS

(71) Applicant: VANESSA RESEARCH, INC., Hamden, CT (US)

(72) Inventors: Dmitry V. KRAVTSOV, Milford, CT (US); Norman GRAY, Hamden, CT (US)

(21) Appl. No.: 16/324,968

(22) PCT Filed: Aug. 15, 2017
(86) PCT No.: PCT/US2017/046861

§ 371 Date: Feb. 12, 2019

Related U.S. Application Data
(60) Provisional application No. 62/375,133, filed on Aug. 15, 2016.

(51) Int. Cl. G01N 1/42; G01N 1/36

(52) U.S. Cl. CPC G01N 1/42; G01N 2001/366; G01N 1/36

(57) ABSTRACT

The present invention relates to an apparatus for freezing samples such as tissue specimens, particularly for rapidly freezing multiple specimens without the need to sequentially prepare and freeze each sample individually. The apparatus comprises a mold which can accommodate one or more tissue samples, a hands-free means for supporting the mold, an insulated container for holding a cryogenic material or refrigerant, and an optional cover for the insulated container. The invention also relates to methods for freezing the tissue specimens.

### RELATED APPLICATION

This application claims priority to U.S. Provisional Patent Application Ser. No. 62/375,133 filed on Aug. 15, 2016, the disclosure of which is incorporated by reference herein in its entirety.

### FIELD OF THE INVENTION

The present invention relates to an apparatus for freezing samples such as tissue specimens, particularly for rapidly freezing multiple specimens without the need to sequentially prepare and freeze each sample individually. The apparatus comprises a mold which can accommodate one or more tissue samples, a hands-free means for supporting the mold, an insulated container for holding a cryogenic material or refrigerant, and an optional cover for the insulated container. The invention also relates to methods for freezing the tissue specimens.

### BACKGROUND OF THE INVENTION

The field of translational medicine experienced a rapid growth in the past decade, bringing new requirements and changing the workflow of the laboratories involved in handling patient tissue samples. The ever-growing number of patients constantly increases the workload on the personnel and equipment processing the tissue biopsy materials. Biopsy and tissue samples obtained from patients and animals are often finding further use in research and translational medicine laboratories, resulting in significant variations of sample processing requirements.

It has been noted that “the good old times when specimens arrived in fixative are gone forever.” See, the website Grossing technologies in Surgical Pathology (http://grossing-technology.com/). The requirements of modern pathology often presume ancillary studies which do not tolerate tissue fixation. Under the pressure of fast turnaround times, the specimen is often processed in the fresh state. Furthermore, the demand for histological diagnoses for medical treatments can be great, such as the on-the-spot tumor margin determinations often required during many surgical procedures. Clearly, there is a need to rapidly prepare and evaluate multiple tissue specimens.

There are two main technical methods for freezing tissue samples that are currently in use. The first method involves freezing tissue samples in a cryostat (See C1a of FIG. 1), in the metal block provided with the instrument. However, this method has limitations such as the relatively slow freezing rate due to the relatively high operation temperatures of the equipment (−20 to −50° C. vs. −196° C. for the boiling point of liquid nitrogen); the one-by-one sample freezing method with the provided control arm of the equipment; and the high degree of personnel involvement and attention required by the process. Furthermore, cryostats are often large heavy units of equipment and lack the portability and limited space requirements needed in settings such as operating rooms.

The second current method is to freeze samples by manually placing the tissues into a Dewar flask with liquid nitrogen until the samples are frozen. Even though Dewar flasks can be small and portable, there are limitations. The use of liquid nitrogen in a Dewar flask requires a high degree of personnel attention to the process and has slow operating times due to freezing the samples one-by-one. There is thus a high degree of variability in the prepared samples due to operator and equipment differences, thus resulting in a lack of uniformity in the quality of the resulting tissue specimens. Furthermore, there are hazards to the personnel using Dewar flasks containing liquid nitrogen for freezing tissue samples, because of the splashing and boil-over of the liquid nitrogen that often occurs during the freezing process, which can cause serious frostbite injury to the exposed skin of the personnel.

Finally, low temperature refrigerators, cryogenic containers, and Dewar flasks are available for the long term cold storage of the prepared samples, but these storage means are not intended or useful for the sample preparation itself.

It is apparent there is an unmet need for an apparatus and methods for rapidly freezing tissue samples, particularly multiple tissue samples for histological and research purposes. The apparatuses and methods of the present invention address the shortcomings of the current state of the technology and are specifically designed to quickly, safely and reliably freeze multiple tissue samples to facilitate medical diagnosis or scientific research.

### SUMMARY OF THE INVENTION

The present invention relates to an apparatus for freezing samples such as tissue specimens, particularly for rapidly freezing multiple specimens without the need to sequentially prepare and freeze each sample individually. The apparatus comprises a mold which can accommodate one or more tissue samples, a hands-free means for supporting the mold, an insulated container for holding a cryogenic material or refrigerant, and an optional cover for the insulated container. The invention also relates to methods for freezing the tissue specimens.

### BRIEF DESCRIPTION OF THE DRAWINGS

FIG. 1 depicts the XY, XZ and YZ projected views of the mold. C1a is the mold. C23 is a conical recess in the mold, it is also the means to hold the sample oriented via the conical recess, and it is also the means to shape the sample and embedding medium into a conical shape.

FIG. 2 depicts a 3-dimensional perspective view of the mold of FIG. 1.

FIG. 3 depicts a 3-dimensional exploded perspective view of a multiple-mold cassette with cover. C6 depicts an embodiment of the cassette with four molds. C33 depicts an embodiment for the means to shape the sample and embedding medium into a rectangular shape. C39(a)(i) is an individual mold within the cassette. C39(a)(ii) shows lines of perforation separating individual molds within a cassette. C39(a)(iii) is a handle. C39(a)(iv) is a cover.

FIG. 4 depicts the XY, XZ and YZ projected views of a platform for the apparatus. C1(b) is the platform, which can be a rectangular platform allowing for orientation within the container, or alternatively an adjustable platform. C8 is an aperture. C9 is a raised edge. C11 is a handle. C12 is an indentation to facilitate mold removal, which can be a series of perforations as seen in the YZ and XZ projections.

FIG. 5 depicts the XY, XZ and YZ projected views of the insulated container of the apparatus. C1c is an insulated container. C7 is a ledge. C14 and C15 are sponge inserts. C29 is a leg.

FIG. 6 depicts the XY, XZ and YZ projected views of the removable cover, C26, of the apparatus, which can further have a hinge or be adjustable.

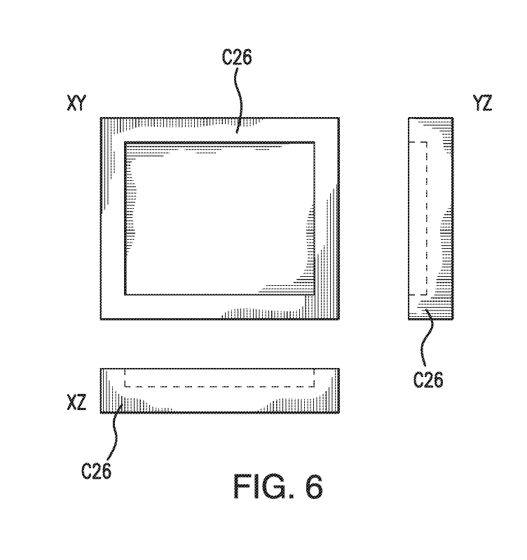

FIG. 7 depicts an exploded view for the assembly of an insulated container (C1c) with a ledge (C7), sponges (C14, 15), gasket (C10), comprising Part B. Also, depicted is the platform (C1b) with apertures (2), comprising Part A. Additionally depicted is a cover (C26).

FIG. 8 depicts an exploded view for the assembly of insulated container (C1c) and sponges (C14, 15), together comprising Part B. Also depicted is an optional cassette (C6). Additionally depicted is a cover (C26).

FIG. 9 depicts an exploded view for the assembly of an alternative embodiment of the insulated container (C1c), a radiator (C74) with fins and heat sink (C20 and C21), a platform (C1b) with embedded metal trays (C2) as a means to support molds, and a cover or lid (C26).

### DETAILED DESCRIPTION OF THE INVENTION

The present invention relates to an apparatus for forming and freezing tissue specimens, comprising:

(a) one or more molds which can accommodate one or more tissue specimens,

(b) a hands-free means for supporting the molds in either direct or indirect contact with a cryogenic medium, and

(c) an insulated container for containing the cryogenic medium.

In another aspect, the present invention relates to an apparatus wherein the hands-free means for supporting the molds is a platform having one or more apertures for supporting or suspending the molds.

In another aspect, the present invention relates to an apparatus wherein the platform is an adjustable platform which can be oriented within the insulated container at a desired position.

In another aspect, the present invention relates to an apparatus wherein the insulated container has a ledge or shelf for supporting the platform.

In another aspect, the present invention relates to an apparatus wherein the platform has a raised edge circumscribing the aperture and substantially perpendicular to the plane of the platform to prevent splashing of the cryogenic medium from the insulated container into the molds.

In another aspect, the present invention relates to an apparatus further comprises a gasket for sealing the platform to the insulated container.

In another aspect, the present invention relates to an apparatus wherein the gasket is oriented beneath and around the circumference of the platform.

In another aspect, the present invention relates to an apparatus wherein the gasket is oriented beneath the platform and is of the same shape as the platform and has apertures corresponding to the apertures in the platform.

In another aspect, the present invention relates to an apparatus wherein the is gasket is porous or semi-porous to allow the cryogenic medium to flow into it for thermal contact with the platform and molds.

In another aspect, the present invention relates to an apparatus wherein the platform further comprises a means for lifting or positioning the platform.

In another aspect, the present invention relates to an apparatus wherein the means for lifting or positioning the platform comprises one or more handles.

In another aspect, the present invention relates to an apparatus wherein the platform further comprises one or more indentations to facilitate placement, positioning, or removal of the molds.

In another aspect, the present invention relates to an apparatus in which the one or more molds are in direct contact with the cryogenic medium.

In another aspect, the present invention relates to an apparatus which further comprises a means to minimize or limit splashing at the liquid-air interface between the cryogenic medium and the molds.

In another aspect, the present invention relates to an apparatus wherein the means to minimize or limit splashing at the liquid-air interface is a porous enclosure.

In another aspect, the present invention relates to an apparatus wherein the porous enclosure is a sponge.

In another aspect, the present invention relates to an apparatus wherein molds are in indirect contact with the cryogenic medium.

In another aspect, the present invention relates to an apparatus wherein the molds have a corresponding cover.

In another aspect, the present invention relates to an apparatus wherein the platform or the cover for the molds have one or more areas on which information regarding the tissue specimens can be indicated.

In another aspect, the present invention relates to an apparatus wherein the one or more molds are one or more tubes.

In another aspect, the present invention relates to an apparatus wherein the tubes have a cap.

In another aspect, the present invention relates to an apparatus wherein the one or more molds are conical.

In another aspect, the present invention relates to an apparatus wherein the one or more molds are in the shape of a fustrum.

In another aspect, the present invention relates to an apparatus wherein the one or more molds are in the shape of a rectangular cuboid.

In another aspect, the present invention relates to an apparatus wherein the insulated container further comprises a lid.

In another aspect, the present invention relates to an apparatus wherein the lid is removable.

In another aspect, the present invention relates to an apparatus wherein the lid is attached to the insulated container via a hinge.

In another aspect, the present invention relates to an apparatus wherein the lid is adjustable to provide the desired access to the insulated container.

In another aspect, the present invention relates to an apparatus wherein the insulated container comprises one or more legs upon which it can stand.

In another aspect, the present invention relates to an apparatus wherein the one or more legs are nonskid legs.

In another aspect, the present invention relates to an apparatus that is portable.

In another aspect, the present invention relates to an apparatus further comprising a handle for carrying the apparatus.

In another aspect, the present invention relates to an apparatus wherein the tissue specimen is formed and frozen in a desired orientation.

In another aspect, the present invention relates to an apparatus wherein the tissue specimen is formed and frozen into a desired shape.

In another aspect, the present invention relates to an apparatus further comprising a cryogenic medium.

In another aspect, the present invention relates to an apparatus wherein the cryogenic medium is selected from liquid nitrogen, dry ice, or a dry ice/solvent mixture.

In another aspect, the present invention relates to an apparatus wherein the solvent of the dry ice/solvent mixture is selected from acetone, ethanol, methanol, propanol, isopropanol, ethylene glycol, 1,2-propane diol, 1,3-propane diol, and mixtures thereof.

In another aspect, the present invention relates to an apparatus further comprising an embedding medium disposed in each mold.

In another aspect, the present invention relates to an apparatus wherein the embedding medium is selected from a material having a freezing point below 0° C.

In another aspect, the present invention relates to a method for forming and freezing tissue specimens comprising using an apparatus as described herein, comprising adding a tissue specimen to one or more molds of the apparatus.

In another aspect, the present invention relates to a method further comprising the step of adding an embedding medium to one or more molds of the apparatus.

In another group of embodiments, the present invention relates to an apparatus for forming, freezing, and storing tissue specimens, comprising:

(a) a cassette further comprising
(i) a platform;
(ii) one or more molds which have been formed into the platform and which can accommodate one or more tissue samples, and
(ii) a detachable, cover for covering the molds,

(b) a hands-free means for supporting the cassette in either direct or indirect contact with a cryogenic medium, and

(c) an insulated container for containing the cryogenic medium.

In another aspect, the present invention relates to an apparatus wherein the hands-free means for supporting the case is a ledge or shelf formed into the insulated container.

In another aspect, the present invention relates to an apparatus wherein the cassette can be oriented within the container at a desired position.

In another aspect, the present invention relates to an apparatus wherein the cassette has perforations in both the platform and the cover, the perforations oriented linearly and crosswise in two dimensions between the molds from each edge of the cassette, said perforations being a means for separating the platform into portions each having an individual covered mold after use.

In another aspect, the present invention relates to an apparatus wherein the platform or cover has one or more areas on which information regarding the tissue specimens can be placed.

In another aspect, the present invention relates to an apparatus further comprising a gasket for sealing the cassette to the insulated container.

In another aspect, the present invention relates to an apparatus wherein the gasket is oriented beneath and around the circumference of the cassette.

In another aspect, the present invention relates to an apparatus wherein the gasket is oriented beneath the platform and is of the same shape as the platform and has apertures corresponding to the apertures in the platform.

In another aspect, the present invention relates to an apparatus wherein the is gasket is porous or semi-porous to allow the cryogenic medium to flow into it for thermal contact with the cassette.

In another aspect, the present invention relates to an apparatus wherein the cassette further comprises a means for lifting or positioning the cassette.

In another aspect, the present invention relates to an apparatus wherein the means for lifting or positioning the cassette comprises one or more handles.

In another aspect, the present invention relates to an apparatus wherein the cassette is in direct contact with the cryogenic medium.

In another aspect, the present invention relates to an apparatus wherein the cassette is in indirect contact with the cryogenic medium.

In another aspect, the present invention relates to an apparatus wherein the insulated container further comprises a lid.

In another aspect, the present invention relates to an apparatus wherein the lid is removable.

In another aspect, the present invention relates to an apparatus wherein the lid is attached to the insulated container via a hinge.

In another aspect, the present invention relates to an apparatus wherein the lid is adjustable to provide the desired access to the insulated container.

In another aspect, the present invention relates to an apparatus wherein the insulated container comprises one or more legs upon which it can stand.

In another aspect, the present invention relates to an apparatus wherein the one or more legs are nonskid legs.

In another aspect, the present invention relates to an apparatus that is portable.

In another aspect, the present invention relates to an apparatus further comprising a handle for carrying the apparatus.

In another aspect, the present invention relates to an apparatus wherein the tissue specimen is formed and frozen in a desired orientation.

In another aspect, the present invention relates to an apparatus wherein the tissue specimen is formed and frozen into a desired shape.

In another aspect, the present invention relates to an apparatus further comprising a cryogenic medium.

In another aspect, the present invention relates to an apparatus wherein the cryogenic medium is selected from liquid nitrogen, dry ice, or a dry ice/solvent mixture.

In another aspect, the present invention relates to an apparatus wherein the solvent of the dry ice/solvent mixture is selected from acetone, ethanol, methanol, propanol, isopropanol, ethylene glycol, 1,2-propane diol, 1,3-propane diol, and mixtures thereof.

In another aspect, the present invention relates to an apparatus further comprising an embedding medium disposed in each mold.

In another aspect, the present invention relates to an apparatus wherein the embedding medium is selected from a material having a freezing point below 0° C.

In another aspect, the present invention relates to a method for forming and freezing tissue specimens comprising using an apparatus according to the present invention, comprising adding a tissue specimen to one or more molds of the apparatus.

In another aspect, the present invention relates to a method comprising the step of adding an embedding medium to one or more molds of the apparatus.

In another group of embodiments, the present invention relates to an apparatus for forming and freezing tissue specimens, comprising:

(a) one or more molds which can accommodate one or more tissue specimens,

(b) a platform comprising one or more heat-conducting indentations for containing the one or more molds, and

(c) an insulated container,

wherein the apparatus can be precooled to a desired target temperature before use.

In another aspect, the present invention relates to an apparatus further comprising a cryogenic medium.

In another aspect, the present invention relates to an apparatus further comprising a radiator for maintaining the desired target temperature.

In another aspect, the present invention relates to an apparatus wherein the heat-conducting indentations and the radiator are made from a heat transfer material having a thermal conductivity has a value of greater than 200 k in units of Watts/(meter K).

In another aspect, the present invention relates to an apparatus wherein the heat transfer material is selected from aluminum, copper, gold, and silver, and mixtures thereof.

In another aspect, the present invention relates to an apparatus wherein the radiator comprises radiating fins.

In another aspect, the present invention relates to an apparatus wherein the insulated container has a ledge or shelf for supporting the platform.

In another aspect, the present invention relates to an apparatus wherein the platform further comprises one or more indentations to facilitate placement, positioning or removal of the molds.

In another aspect, the present invention relates to an apparatus wherein the molds have a corresponding cover.

In another aspect, the present invention relates to an apparatus wherein the molds or covers have one or more areas on which information regarding the tissue specimens can be indicated.

In another aspect, the present invention relates to an apparatus wherein the insulated container further comprises a lid.

In another aspect, the present invention relates to an apparatus wherein the lid is removable.

In another aspect, the present invention relates to an apparatus wherein the lid is attached to the container via a hinge.

In another aspect, the present invention relates to an apparatus wherein the lid is adjustable to provide the desired access to the container.

In another aspect, the present invention relates to an apparatus wherein the insulated container comprises one or more legs upon which it can stand.

In another aspect, the present invention relates to an apparatus wherein the one or more legs are nonskid legs.

In another aspect, the present invention relates to an apparatus that is portable.

In another aspect, the present invention relates to an apparatus further comprising a handle for carrying the apparatus.

In another aspect, the present invention relates to an apparatus wherein the tissue specimen is formed and frozen in a desired orientation.

In another aspect, the present invention relates to an apparatus wherein the tissue specimen is formed and frozen into a desired shape.

In another aspect, the present invention relates to an apparatus further comprising a cryogenic medium.

In another aspect, the present invention relates to an apparatus wherein the cryogenic medium is selected from liquid nitrogen, dry ice, or a dry ice/solvent mixture.

In another aspect, the present invention relates to an apparatus wherein the solvent of the dry ice/solvent mixture is selected from acetone, ethanol, methanol, propanol, isopropanol, ethylene glycol, 1,2-propane diol, 1,3-propane diol, and mixtures thereof.

In another aspect, the present invention relates to an apparatus further comprising an embedding medium disposed in each mold.

In another aspect, the present invention relates to an apparatus wherein the embedding medium is selected from a material having a freezing point below 0° C.

In another aspect, the present invention relates to a method for forming and freezing tissue specimens comprising using an apparatus according to the present invention, comprising adding a tissue specimen to one or more molds of the apparatus.

In another aspect, the present invention relates to a method further comprising the step of adding an embedding medium to one or more molds of the apparatus.

These and other aspects of the invention will become apparent from the disclosure herein.

### Definitions

The term “cryogenic medium” as used herein means a material that is at or capable of providing a very low temperature such as, for example, that of liquid nitrogen, which has a boiling point −196° C. or dry ice, which has a sublimation point of −78.5° C., under normal atmospheric pressure.

The term “hands-free” as used herein means that the apparatus of the present invention provides a means where the operator does not have to hold the molds, platforms, or cassettes involved with the preparation and freezing of the samples, as these are supported during sample preparation and freezing.

The term “refrigerant” as used herein is meant to also include a cryogenic medium.

Apparatus for Freezing Specimens

The apparatus of the present invention can be viewed as comprising two part: Part A comprises those components for holding and containing the samples, such as the platform, molds, cassettes, covers for the molds and the like. Part B comprises those components providing the cooling and freezing function of the apparatus for the cooling and freezing of the samples.

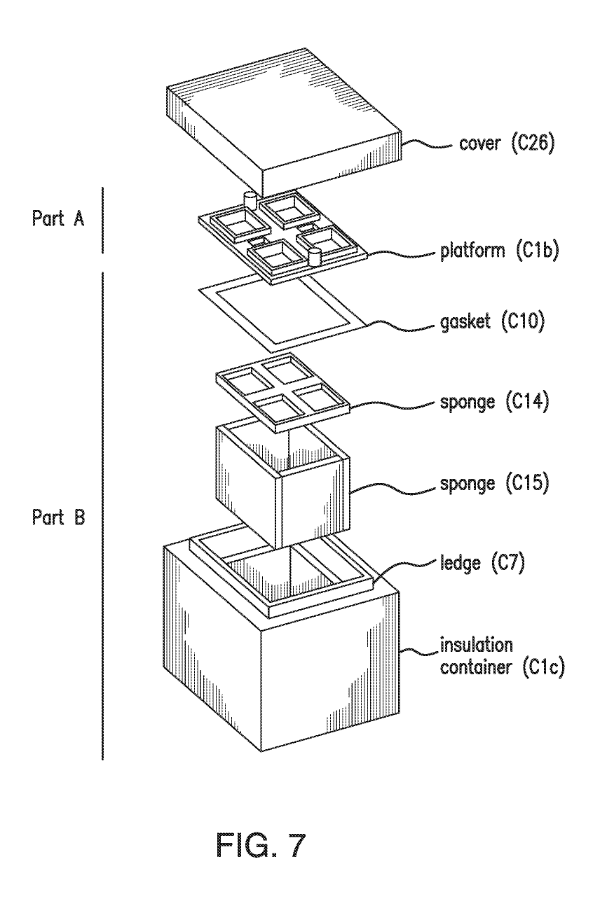

Part A (see FIG. 7) is a platform that serves primarily three functions: (1). The platform provides a hands-free support for the molds (i.e. the cryogenic molds or “cryomolds”). (2). Allows for simultaneous freezing of multiple samples, if desired, e.g., four or more samples, depending on the design chosen, and. (3). Physically isolates the operator's hands from the cryogenic medium or cooling means, thus preventing injuries from accidental exposure. Part A can be molded from a single piece of dimensionally stable plastic and is designed to be exchangeable and disposable. Variants of Part A with perforated slots accommodating cryomolds of various sizes (small, medium and large) can be provided. The splashing of chemicals can be minimized or prevented by attaching small ridges made from a spongy plastic material around the perimeter of the slots. The components of Part A, can be swappable or interchangeable.

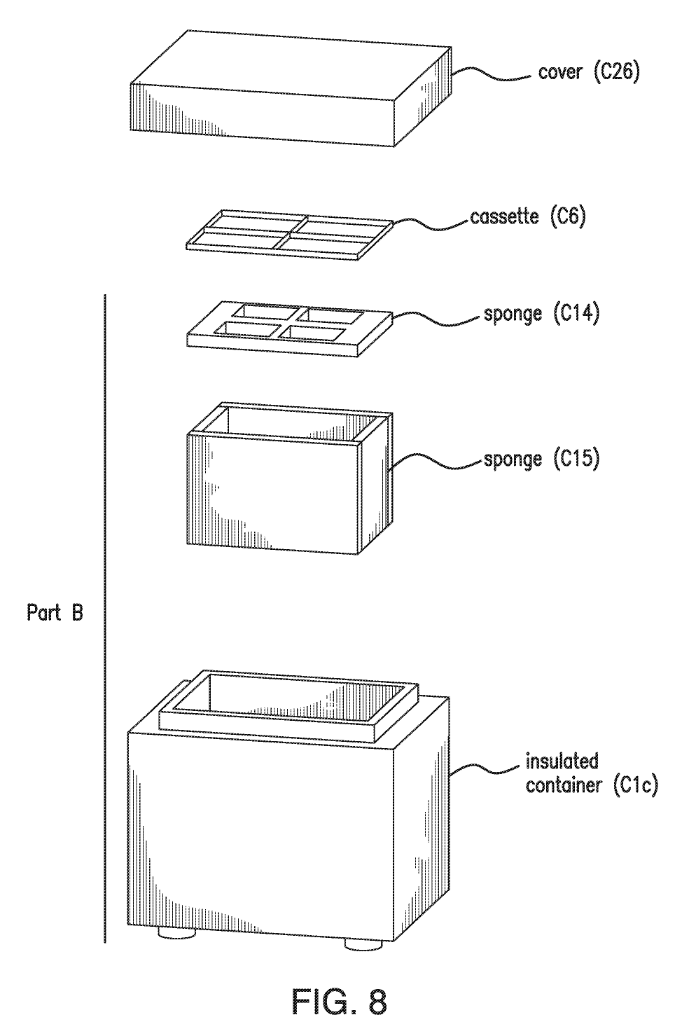

Part B (see FIG. 7 and FIG. 8) is the cooling device that serves primarily two functions: (1) The cooling device contains the cryogenic medium or cooling means and acts as a thermal insulator, reducing thermal exchange and further reducing splashing, and. (2) The cooling device provides the mechanical support and stability for the swappable or interchangeable components of Part A. Part B has an inner chamber that is filled with the cryogenic medium or a cooling means, and in some embodiments a means to minimize or limit the splashing at the liquid-air interface between the cryogenic medium and the molds (e.g., a porous enclosure such as a sponge material), underlying Part A, a rigid outer chamber made from plastic that can be sterilized, an insulating filling between the outer walls and the inner chamber, and a gasket either surrounding the underlying perimeter of the platform or underlying the platform.

Molds

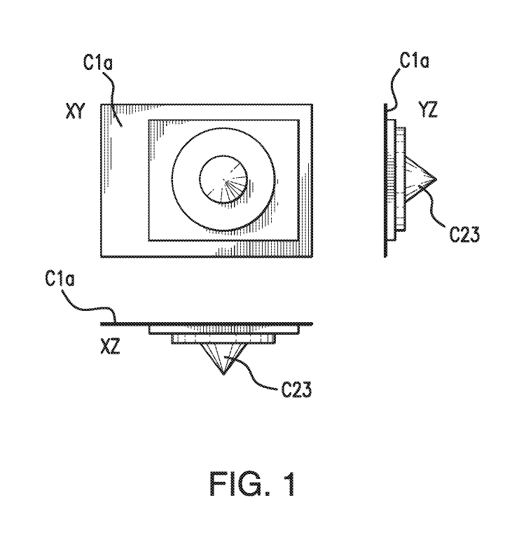

The mold (FIG. 1) is a pre-formed structure, preferably made from a plastic, that is designed to accommodate and contain the tissue samples that are being prepared and frozen. The main functions of the mold are: (1) to contain the sample; (2) to contain the embedding medium;

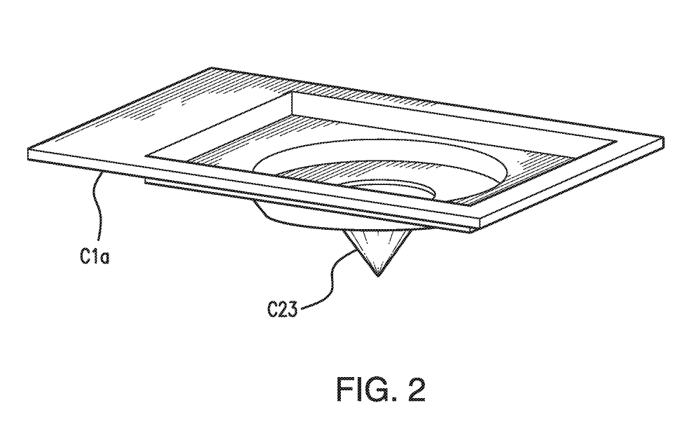

(3) to orient the sample in a desired position and keep it oriented until it is encased in the frozen embedding medium; (4) to provide a definitive shape for the embedding medium with a sample within; (5) to isolate the embedding medium and the sample within from the cryogenic medium; (6) to provide the means for labeling, and (7) to provide long-term storage of the frozen sample. The mold can be made in a variety of shapes and sizes and can usually be made of thin plastic (FIG. 1), and in some embodiments with several recesses engineered in to it to contain, shape and orient the embedding medium and the sample within (C23, C32, and C33 of FIG. 1), and an additional space for labeling the mold. While the general shape, size and orientation of the mold as a whole is designed to fit the dimensions of the apparatus, the shape, size and number of recesses can vary. Several variants of the mold can be designed with conical shapes, in the shape of a fustrum, or in the shape of a rectangular cuboid (FIG. 2), and with recesses of various sizes (1 mm and larger) and number (two or more) intended to accommodate smaller and larger samples. In another aspect, the present invention relates to an apparatus wherein the one or more molds are one or more tubes. In another aspect, the present invention relates to an apparatus wherein the tubes have a cap.

Means for Supporting the Mold (The Platform)

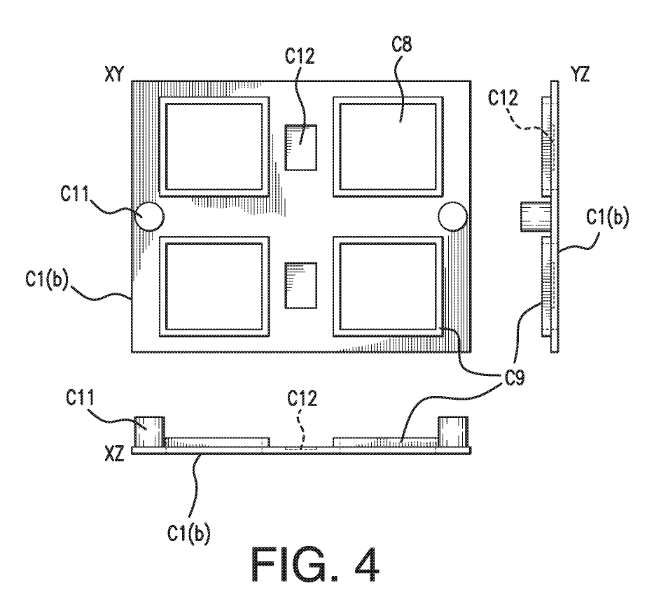

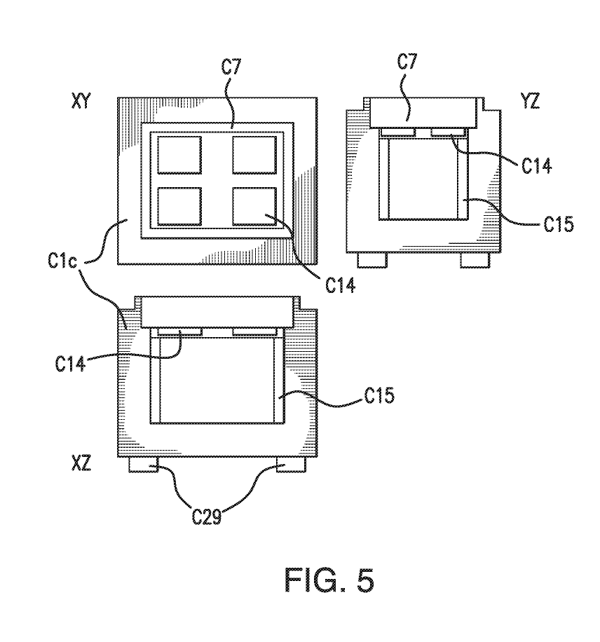

The platform can be a pre-formed square, rectangular, round, or other-shaped structure (FIG. 4) that is oriented within the insulated container (FIG. 5). It provides support for the molds in such a way so that the recesses are in direct contact with the cryogenic medium, while the upper surface of the mold is isolated from the cryogenic medium. In some embodiments, the recesses of the molds are in contact with the cryogenic medium through apertures cut out in the platform (C8 of FIG. 4). There can be one or more apertures per platform. In some embodiments, each aperture is surrounded by a ridge, which can be made from a porous material, designed to reduce the risk of cryogenic medium leaks between the platform and the mold (C9 of FIG. 4). The platform is sized to fit the container and to accommodate one or more molds. In some embodiments, there is a small handle attached to the platform (C11 of FIG. 4) to facilitate its placement, positioning, and removal from the insulated container. In some embodiments, there is a small indentation in the material of the platform to facilitate the removal of the molds (FIG. 4).

Cassette with Multiple Molds

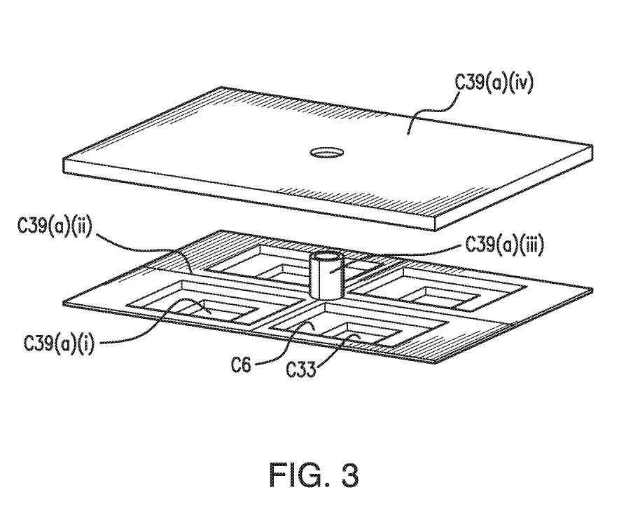

In further embodiments, the apparatus comprises a cassette incorporating one or more molds to permit the simultaneous preparation and freezing of multiple unrelated samples (FIG. 3). The cassette is of a larger rectangular shape [or other shape] matching the dimensions of the platform and apertures thereof, and can be engineered by fusing two or more molds together, thus comprising a unit of two or more molds (C39(a)(i) of FIG. 3). In some embodiments, the cassette can comprise one or more lines of perforation, e.g., oriented linearly and crosswise in two dimensions between the molds from each edge of the cassette, to provide the user with the option to store the entire cassette as a whole, or break it into individual molds for separate storage (C39(a)(ii) of FIG. 3). In some embodiments, a protective cover is provided, also with optional perforations, with the cassette (C39(a)(iv) of FIG. 3.).

Insulated Container

The insulated container (FIG. 5) contains the cryogenic medium (e.g., liquid nitrogen, dry ice or a dry ice/solvent mixture) to freeze the specific tissues sample. In addition, the container provides the support for the platform via a ledge (C7 of FIG. 5). The shape of the container, can be rectangular, square, or round, or of some other shape. A rectangular container is shown in C1c of FIG. 5. The shape and outer dimensions of the container will depend on the design and shape of the platform and the internal aspects of the container.

The exterior of the container can be made of different materials, including, but not limited to metals (such as aluminum, steel, titanium, silver, gold, or platinum, or metal mixtures of alloys), glass (e.g., borosilicate glass), plastic, and organic or inorganic materials, that are preferably resistant to external environment exposure. The outer shell of the container can be held together by the means of welding, gluing, stamping, or fastening. The thickness of the outer shell will depend on the properties of the material it is built from. The interior chamber can contain the cryogenic medium and can assume a square, rectangular, round, or other desired shape. The interior (internal) shell or chamber can be made of metal, plastic, foam, or glass, and should be capable of withstanding the temperature of liquid nitrogen (boiling point of −196° C.) or below and the presence of solvents, without deformation, deterioration, or fragmentation. The material for the interior shell or chamber should have low thermal conductivity to prevent heat loss to the cryogenic medium. The interior chamber can be held together by the means of welding, gluing, stamping, or fastening. A ledge can be engineered into the top part of the interior chamber (C7 of FIG. 7) to provide means to support the platform so that the recess of the mold rests on the platform and are in direct contact with the cryogenic medium. The size and shape of the ledge will depend on the size of the platform. A porous gasket (C10 of FIG. 7) can be placed on the ledge to prevent leakage of the cryogenic medium.

Inside the interior chamber a porous structure, such as sponges, can be placed (C14 and C15 of FIG. 5) directly under the platform. The purpose of this structure is to remove or diminish the free liquid from the interface between the cryogenic medium and the molds, and in doing so to further minimize the risk of splashing of the cryogenic medium.

The space between the inner and outer container can be filled with an insulating material made from foam or other type of material. The material in this middle section space is contained by compression from the external and internal sections and by adhesives. The thickness of the container with will depend on the R-value, i.e. the insulation factor, of the materials used.

In some embodiments, the apparatus comprises an insulated container further comprising a lid, which can be removable. In other embodiments the lid is attached to the insulated container via a hinge, and can be adjustable to provide the desired degree of access to the insulated container.

In some embodiments, the apparatus is portable and can comprise carrying handles. The apparatus can also comprise one or more legs or feet, particularly nonskid legs or feet (C29 of FIG. 5).

Cryogenic Medium

The term “cryogenic medium” as used herein means a material that is at or capable of providing a very low temperature such as that of liquid nitrogen, which has a boiling point of −196° C. or dry ice, which is a sublimation temperature of −78.5° C., both at normal atmospheric pressure. As disclosed herein, the cryogenic medium is selected from liquid nitrogen, dry ice, or a dry ice/solvent mixture. The dry ice/solvent mixture is selected from acetone, ethanol, methanol, propanol, isopropanol, ethylene glycol, 1,2-propane diol, 1,3-propane diol, and mixtures thereof, as well as other such suitable solvents. Also, a mixture of water with hydroxyethyl cellulose, sodium polyacrylate, or vinyl-coated silica gel, which has been prechilled to the desired temperature can be used.

### Alternative Embodiments

In another embodiment, the cassette can be used without a platform, while resting directly on the porous structure of Part B (FIG. 8).

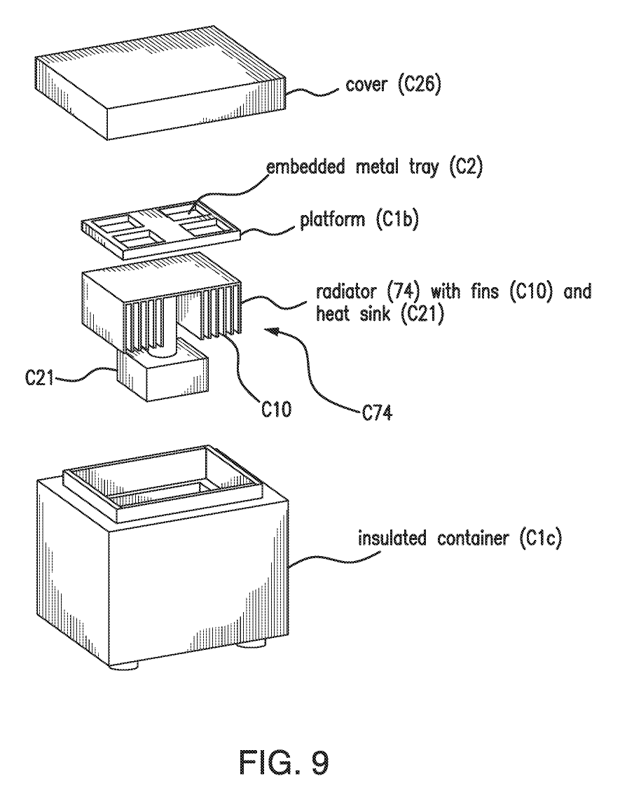

In another embodiment, the apparatus variant is a self-contained, insulated, and refrigerated unit that simply requires the entire apparatus to be chilled in a freezer before use (FIG. 9). This unit obviates the need for liquid nitrogen and/or a dry ice/solvent bath. Instead, the entire apparatus is a sealed unit which is pre-filled with the high thermal capacity medium, serving as a refrigerant, and kept chilled, for example, in a −80° C. freezer. When in use, the heat is removed from the samples through the indirect contact with the refrigerant by the means of embedded metal trays (C2) of FIG. 9). The shape of the entire unit can be square, rectangular or round, although other shapes and designs can be made. The high thermal capacity medium within the unit can be a mixture of water with hydroxyethyl cellulose, sodium polyacrylate, or a vinyl-coated silica gel, which is pre-chilled to −80° C. for use. The unit is intended to be kept under refrigerated conditions when not in use, with the heat sink outer surface revealed to aid in the cooling of the insulated refrigerant within the apparatus. When the apparatus is in use, the removable cover for the apparatus (C26 of FIG. 9) is placed under the unit, where it serves as a temporary insulator towards the exposed heat sink surface to reduce the effect of heat transfer from the environment into the refrigerant from the heat sink. Alternatively, the heat sink can be exposed during usage, provided there is a cooling medium in which the unit is submerged (e.g., dry ice), extending the duration of usage before requiring the unit to be re-chilled in the freezer. The heat sink core can be a circular, square, or other shaped cylinder situated at the bottom of the unit with the outer surface exposed to the outside environment, which is connected to the apertures via a radiator with heat pipes or heat transfer fins protruding internally into the refrigerant, which increases the surface area available for heat exchange (FIG. 9: radiator (C74) with fins (C10) and heat sink (C21). This design serves to extend the duration of the optimal temperature on the surface of the aperture. The heat sink core and the heat pipes/heat transfer fins can be made from a heat transfer material having a thermal conductivity value of greater than 200 k in units of Watts/(meter K), for example aluminum, copper, gold, silver, or any other alloy/variation thereof.

The unit can comprise one or more, preferably two or more, trays embedded into the upper surface of the unit, which can be made of a heat transfer material having a thermal conductivity value of greater than 200 k in units of Watts/(meter K), for example aluminum, copper, gold, silver, or any other alloy/variation thereof. A variant with four trays is shown in FIG. 4. Each of the individual trays can be surrounded and insulated with a material with a relatively high R-value, i.e. insulation factor, such as polyisocyanurate foam or other type of high density insulation medium. The desired R-value for the insulating material is 2 and above. The purpose of surrounding the aperture with insulation is to decrease the heat transfer of the cryogenic medium to the environment in the space between the aperture, and to focus the effectiveness of heat transfer at the aperture surface. Similarly, the insulation for the cover and the unit itself can also be made from a thermal insulator with a relatively high R-value. The purpose of the requirement for the insulation is to maximize the duration of time the cryogenic medium will retain its operating temperature. The inner chamber of the unit containing the cryogenic medium should be made with a material with low heat conductivity capable of withstanding the very low temperatures of the cryogenic medium, and made from either a metal/alloy, borosilicate glass, or a plastic polymer. Alternatively, the inner chamber can also be part of an insulation layer. Also, for the exterior of the unit, the surface can be made from a high wear material with a relatively low heat conductivity value, which can be made from a thick plastic, and also feature a handle for easy transportation. For the construction of the unit, the exterior and the cover can be molded, welded, glued or fastened together depending on the material chosen. The inner chamber should be leak-proof, therefore requiring the chamber to be either welded, glued or be formed as a pre-made container depending on the material and method of insulation used. The platform containing the apertures can also be stamped, welded or molded to shape depending on the material and method of insulation chosen.

Method for Freezing Specimens

To freeze tissue sample, the user of the apparatus of the present invention can perform the following steps:
1. Fill the inner chamber of the insulated container with the cryogenic medium, e.g., liquid nitrogen.
2. Place the means for minimizing the splashing of the cryogenic medium, such as a sponge, directly on top of the liquid nitrogen.
3. Mount Part A of the apparatus on to Part B of the apparatus.
4. Label the mold and fill it with an embedding medium.
5. Place the biopsy sample into the mold containing the embedding medium.
6. Place the mold containing the biopsy sample into the aperture.
7. Repeat steps 4-6 for each sample to be frozen.
8. Remove the frozen molds from the apparatus.
9. After use, empty the container and store it covered.

The action sequence described above eliminates the necessity to manually, individually hold each sample for freezing, and liberates the operator's time for other activities, such as processing the next sample. Using liquid nitrogen as the medium ensures a consistent freezing temperature (−196° C.) and rapid freezing, as compared to the higher operating temperatures of cryostats (−20 to −50° C.). Elimination of the air-liquid interface with porous gaskets reduces splashing and minimizes the risk of exposure of the user to the medium. Pre-labeling the molds helps with sample identification and allows for simultaneous processing of un-related tissue samples.

Compared to commercially existing molds that must be manually manipulated for each sample, e.g., Cryomolds (TissueTek), the apparatus of the present invention provides a decrease in freezing time by an average of about 2-3 minutes per mold, with a cumulative time saving effect of about 10 min. per 4 molds; about 20 minutes per 8 molds, and about 30 minutes per 12 molds. This is a significant time and cost saving, particularly for high volume tissue sample preparation.

### INCORPORATION BY REFERENCE

The entire disclosure of each of the patent documents, including certificates of correction, patent application documents, scientific articles, governmental reports, websites, and other references referred to herein is incorporated by reference herein in its entirety for all purposes. In case of a conflict in terminology, the present specification controls.

### EQUIVALENTS

The invention can be embodied in other specific forms without departing from the spirit or essential characteristics thereof. The foregoing embodiments are to be considered in all respects illustrative rather than limiting of the invention described herein. In the various embodiments of the methods and systems of the present invention, where the term comprises is used with respect to the recited steps or components, it is also contemplated that the methods and systems consist essentially of, or consist of, the recited steps or components. Further, it should be understood that the order of steps or order for performing certain actions is immaterial so long as the invention remains operable. Moreover, two or more steps or actions can be conducted simultaneously.

In the specification, the singular forms also include the plural forms, unless the context clearly dictates otherwise. Unless defined otherwise, all technical and scientific terms used herein have the same meaning as commonly understood by one of ordinary skill in the art to which this invention belongs. In the case of conflict, the present specification will control.

Furthermore, it should be recognized that in certain instances a composition can be described as being composed of the components prior to mixing, because upon mixing certain components can further react or be transformed into additional materials.

All percentages and ratios used herein, unless otherwise indicated, are by weight.

What is claimed is:

1. An apparatus for forming and freezing tissue specimens, comprising:
(a) one or more molds which can accommodate one or more tissue specimens,
(b) a hands-free means for supporting the molds in either direct or indirect contact with a cryogenic medium, and
(c) an insulated container for containing the cryogenic medium.

2. An apparatus according to claim 1 wherein the hands-free means for supporting the molds is a platform having one or more apertures for supporting or suspending the molds.

3. An apparatus according to claim 2 wherein the platform is an adjustable platform which can be oriented within the insulated container at a desired position.

4. An apparatus according to claim 2 wherein the insulated container has a ledge or shelf for supporting the platform.

5. An apparatus according to claim 2 wherein the platform has a raised edge circumscribing the aperture and substantially perpendicular to the plane of the platform to prevent splashing of the cryogenic medium from the insulated container into the molds.

6. An apparatus according to claim 2 further comprising a gasket for sealing the platform to the insulated container.

7. An apparatus according to claim 6 wherein the gasket is oriented beneath and around the circumference of the platform.

8. An apparatus according to claim 6 wherein the gasket is oriented beneath the platform and is of the same shape as the platform and comprises apertures corresponding to the apertures in the platform.

9. An apparatus according to claim 6 wherein the gasket is porous or semi-porous to allow the cryogenic medium to flow into it for thermal contact with the platform and molds.

10. An apparatus according to claim 2 wherein the platform further comprises a means for lifting or positioning the platform.

11. An apparatus according to claim 10 wherein the means for lifting or positioning the platform comprises one or more handles.

12. An apparatus according to claim 11 wherein the platform further comprises one or more indentations to facilitate placement, positioning, or removal of the molds.

13. An apparatus according to claim 2 in which the one or more molds are in direct contact with the cryogenic medium.

14. An apparatus according to claim 13 which further comprises a means to minimize splashing at the liquid-air interface between the cryogenic medium and the molds.

15. An apparatus according to claim 14 wherein the means to minimize splashing at the liquid-air interface is a porous enclosure.

16. An apparatus according to claim 15 wherein the porous enclosure is a sponge.

17. An apparatus according to claim 2 wherein the molds are in indirect contact with the cryogenic medium.

18. An apparatus according to claim 2 wherein the molds further comprise a corresponding cover.

19. An apparatus according to claim 18 wherein the platform or the cover for the molds have one or more areas (regions) on which information regarding the tissue specimens can be indicated (e.g., placed or written).

20. An apparatus according to claim 2 wherein the one or more molds are one or more tubes.

21. An apparatus according to claim 20 wherein the tubes further comprise a cap.

22. An apparatus according to claim 2 wherein the one or more molds are conical.

23. An apparatus according to claim 2 wherein the one or more molds are in the shape of a fustrum.

24. An apparatus according to claim 2 wherein the one or more molds are in the shape of a rectangular cuboid.

25. An apparatus according to claim 1 wherein the insulated container further comprises a lid.

26. An apparatus according to claim 25 wherein the lid is removable.

27. An apparatus according to claim 25 wherein the lid is attached to the insulated container via a hinge.

28. An apparatus according to claim 27 wherein the lid is adjustable to provide the desired access to the insulated container.

29. An apparatus according to claim 1, wherein the insulated container comprises one or more legs or feet upon which it can stand.

30. An apparatus according to claim 29, wherein the one or more legs or feet are nonskid legs or feet.

31. An apparatus according to claim 1 that is portable.

32. An apparatus according to claim 31 further comprising a handle (this is separate and distinguished from the handle or handles for the platform or cassette) for carrying the apparatus.

33. An apparatus according to claim 1 wherein the tissue specimen is formed and frozen in a desired orientation.

34. An apparatus according to claim 1 wherein the tissue specimen is formed and frozen into a desired shape.

35. An apparatus according to claim 1 further comprising a cryogenic medium.

36. An apparatus according to claim 35 wherein the cryogenic medium is selected from liquid nitrogen, dry ice, or a dry ice/solvent mixture.

37. An apparatus according to claim 36 wherein the solvent of the dry ice/solvent mixture is selected from acetone, ethanol, methanol, propanol, isopropanol, ethylene glycol, 1,2-propane diol, 1,3-propane diol, and mixtures thereof.

38. An apparatus according to claim 1 further comprising an embedding medium disposed in each mold.

39. An apparatus according to claim 38 wherein the embedding medium is selected from a material having a freezing point below 0° C.

40. A method for forming and freezing tissue specimens comprising using an apparatus according to claim 1, comprising adding a tissue specimen to one or more molds of the apparatus.

41. A method according to claim 40 further comprising the step of adding an embedding medium to one or more molds of the apparatus.

42. An apparatus for forming, freezing, and storing tissue specimens, comprising:
(a) a cassette further comprising
(i) a platform;
(ii) one or more molds which have been formed into the platform and which can accommodate one or more tissue samples, and
(ii) a detachable, cover for covering the molds,
(b) a hands-free means for supporting the cassette in either direct or indirect contact with a cryogenic medium, and
(c) an insulated container for containing the cryogenic medium.

43. An apparatus according to claim 42 wherein the hands-free means for supporting the case is a ledge or shelf formed into the insulated container.

44. An apparatus according to claim 43 wherein the cassette can be oriented within the container at a desired position.

45. An apparatus according to claim 44 wherein the cassette has perforations in both the platform and the cover, the perforations being oriented linearly and crosswise in two dimensions between the molds from each edge of the cassette, said perforations being a means for separating the platform into portions such that each portion comprises an individual covered mold after separation.

46. An apparatus according to claim 42 wherein the platform or cover has one or more areas (regions) on which information regarding the tissue specimens can be indicated (e.g., placed or written).

47. An apparatus according to claim 42 further comprising a gasket for sealing the cassette to the insulated container.

48. An apparatus according to claim 47 wherein the gasket is oriented beneath and around the circumference of the cassette.

49. An apparatus according to claim 47 wherein the gasket is oriented beneath the platform and is of the same shape as the platform and comprises apertures corresponding to the apertures in the platform.

50. An apparatus according to claim 47 wherein the is gasket is porous or semi-porous to allow the cryogenic medium to flow into it for thermal contact with the cassette.

51. An apparatus according to claim 42 wherein the cassette further comprises a means for lifting or positioning the cassette.

52. An apparatus according to claim 51 wherein the means for lifting or positioning the cassette comprises one or more handles.

53. An apparatus according to claim 52 wherein the cassette is in direct contact with the cryogenic medium.

54. An apparatus according to claim 52 wherein the cassette is in indirect contact with the cryogenic medium.

55. An apparatus according to claim 42 wherein the insulated container further comprises a lid.

56. An apparatus according to claim 55 wherein the lid is removable.

57. An apparatus according to claim 55 wherein the lid is attached to the insulated container via a hinge.

58. An apparatus according to claim 57 wherein the lid is adjustable to provide the desired access to the insulated container.

59. An apparatus according to claim 42, wherein the insulated container comprises one or more legs or feet upon which it can stand.

60. An apparatus according to claim 59, wherein the one or more legs or feet are nonskid legs or feet.

61. An apparatus according to claim 42 that is portable.

62. An apparatus according to claim 61 further comprising a handle for carrying the apparatus.

63. An apparatus according to claim 42 wherein the tissue specimen is formed and frozen in a desired orientation.

64. An apparatus according to claim 63 wherein the tissue specimen is formed and frozen into a desired shape.

65. An apparatus according to claim 42 further comprising a cryogenic medium.

66. An apparatus according to claim 65 wherein the cryogenic medium is selected from liquid nitrogen, dry ice, or a dry ice/solvent mixture.

67. An apparatus according to claim 66 wherein the solvent of the dry ice/solvent mixture is selected from acetone, ethanol, methanol, propanol, isopropanol, ethylene glycol, 1,2-propane diol, 1,3-propane diol, and mixtures thereof.

68. An apparatus according to claim 42 further comprising an embedding medium disposed in each mold.

69. An apparatus according to claim 68 wherein the embedding medium is selected from a material having a freezing point below 0° C.

70. A method for forming and freezing tissue specimens comprising using an apparatus according to claim 42, comprising adding a tissue specimen to one or more molds of the apparatus.

71. A method according to claim 70 further comprising the step of adding an embedding medium to one or more molds of the apparatus.

72. An apparatus for forming and freezing tissue specimens, comprising:
(a) one or more molds which can accommodate one or more tissue specimens,
(b) a platform comprising one or more heat-conducting indentations for containing the one or more molds, and
(c) an insulated container,
wherein the apparatus can be precooled to a desired target temperature before use.

73. An apparatus according to claim 72 which further comprising a cryogenic medium.

74. An apparatus according to claim 72 further comprising a radiator for maintaining the desired target temperature.

75. An apparatus according to claim 74 wherein the heat-conducting indentations and the radiator are each made from a heat transfer material having a thermal conductivity value of greater than 200 k in units of Watts/(meter K).

76. An apparatus according to claim 75 wherein the heat transfer material is selected from aluminum, copper, gold, and silver, and mixtures thereof.

77. An apparatus according to claim 74 wherein the radiator comprises radiating fins.

78. An apparatus according to claim 72 wherein the insulated container has a ledge or shelf for supporting the platform.

79. An apparatus according to claim 78 wherein the platform further comprises one or more indentations to facilitate placement, positioning or removal of the molds.

80. An apparatus according to claim 72 wherein the molds further comprise a corresponding cover.

81. An apparatus according to claim 80 wherein the molds or covers comprise one or more areas (regions) on which information regarding the tissue specimens can be indicated (e.g., placed or written).

82. An apparatus according to claim 72 wherein the insulated container further comprises a lid.

83. An apparatus according to claim 82 wherein the lid is removable.

84. An apparatus according to claim 82 wherein the lid is attached to the container via a hinge.

85. An apparatus according to claim 84 wherein the lid is adjustable to provide the desired access to the container.

86. An apparatus according to claim 72, wherein the insulated container comprises one or more legs or feet upon which it can stand.

87. An apparatus according to claim 86, wherein the one or more legs or feet are nonskid legs or feet.

88. An apparatus according to claim 72 that is portable.

89. An apparatus according to claim 88 further comprising a handle for carrying the apparatus.

90. An apparatus according to claim 72 wherein the tissue specimen is formed and frozen in a desired orientation.

91. An apparatus according to claim 72 wherein the tissue specimen is formed and frozen into a desired shape.

92. An apparatus according to claim 73 wherein the cryogenic medium is selected from liquid nitrogen, dry ice, or a dry ice/solvent mixture.

93. An apparatus according to claim 92 wherein the solvent of the dry ice/solvent mixture is selected from acetone, ethanol, methanol, propanol, isopropanol, ethylene glycol, 1,2-propane diol, 1,3-propane diol, and mixtures thereof.

94. An apparatus according to claim 72 further comprising an embedding medium disposed in each mold.

95. An apparatus according to claim 94 wherein the embedding medium is selected from a material having a freezing point below 0° C.

96. A method for forming and freezing tissue specimens comprising using an apparatus according to claim 72, comprising adding a tissue specimen to one or more molds of the apparatus.

97. A method according to claim 96 further comprising the step of adding an embedding medium to one or more molds of the apparatus.
